(19) United States
(12) Patent Application Publication
(10) Pub. No.: US 2022/0272127 A1
(43) Pub. Date: Aug. 25, 2022

(54) AUTOMATIC INSERTION OF SECURITY POLICIES FOR WEB APPLICATIONS

(71) Applicant: Tala Security, Inc., Fremont, CA (US)

(72) Inventors: Siddhesh Shripad Yawalkar, Sunnyvale, CA (US); Hemant Puri, Fremont, CA (US); Nicholas Maxwell, Covington, WA (US); Sandeep Bhatkar, Sunnyvale, CA (US); Nhan Nyugen, Newark, CA (US); Anindita Bhattacharjee, Milipitas, CA (US)

(21) Appl. No.: 17/386,870

(22) Filed: Jul. 28, 2021

Related U.S. Application Data
(60) Provisional application No. 63/031,741, filed on May 29, 2020.

(51) Int. Cl. H04L 29/06

(52) U.S. Cl. CPC H04L 63/20; H04L 63/1433; H04L 63/168

(57) ABSTRACT

Techniques to facilitate automatic insertion of security policies for web applications are disclosed herein. In at least one implementation, security configuration information for a web application is received. A web request for a web resource is received and processed to determine an HTTP security header for insertion into a web response to the web request based on properties of the web request. The web response is intercepted and the HTTP security header is inserted into the web response to generate a modified web response. The web response is processed to determine a security enhancement to apply to the web resource based on the security configuration information. The security enhancement is applied to the web resource to generate a modified web resource. The modified web response and the modified web resource are provided to a client application in response to the web request for the web resource.

### RELATED APPLICATIONS

This application claims the benefit of, and priority to, U.S. Provisional Patent Application No. 63/031,741, entitled “Method for Injection and Disseminating Web Security and Privacy Policies for Web Applications”, filed on May 29, 2020, which is hereby incorporated by reference in its entirety for all purposes.

### TECHNICAL BACKGROUND

Application-layer attacks are a major vulnerability of the security industry and are one of the largest sources of data breaches. Application-layer attacks exploit vulnerabilities within an application as well as susceptible components and unsecure coding practices used in building the application. Existing methodologies to protect an application rely on analysis techniques to identify already-published or known bugs and vulnerabilities, and then either requiring the application software developers to fix those bugs and remove the vulnerabilities in the application code, or generating virtual patches that can be configured on network firewalls and intrusion prevention systems to prevent the exploitation of those vulnerabilities. However, this blacklist approach, which attempts to prevent known malicious users, code, or inputs from reaching the application, offers inadequate protection because it only protects against attack vectors and vulnerabilities that have been previously discovered.

Web applications typically integrate code and resources from dozens of third-party service providers, including content delivery networks (CDNs) and third-party JavaScript libraries, and may range in function from user analytics to marketing tags, among other examples. Recent studies have found that almost two thirds of the content and code at websites is loaded from third parties. A significant portion of this content comprises executable scripts with direct security impact on a website. A greater security risk is due to the way in which many advertising platforms are set up, where the advertising host sites may not even be aware of which servers are placing content on the website. In the absence of proper vetting for third-party executable content, this content may be compromised or malicious. Many recent examples of crypto jacking attacks have transpired involving a third-party library serving crypto-mining code to users from thousands of websites. In addition, recent breaches of user data on many popular websites have been attributed to compromised third-party JavaScript files.

Modern web architecture relies heavily on JavaScript and enabling third-party code to make client-side network requests. These innovations are built on client-heavy frameworks such as Angular, Ember, React, and Backbone that leverage the processing power of the browser to enable the execution of code directly on the client interface such as a web browser. These third-party integrations may provide richness (chat tools, images, fonts) or extract analytics. Today, up to seventy percent of the code executing and rendering on a client browser comes from such integrations. All of these software integrations provide avenues for potential vulnerabilities. Web browser standards such as content security policy (CSP), subresource integrity (SRI), and hypertext transport protocol (HTTP) strict transport security (HSTS) can help to prevent exploitation of such vulnerabilities.

### OVERVIEW

Techniques to facilitate automatic insertion of security policies for web applications are disclosed herein. In at least one implementation, a security web module is executed in a client application to perform operations. The operations comprise receiving security configuration information for a web application. The operations further comprise intercepting a web request for a web resource associated with the web application and processing the web request to determine a hypertext transfer protocol (HTTP) security header for insertion into a web response to the web request based on properties of the web request. The operations further comprise intercepting the web response to the web request and inserting the HTTP security header into the web response to generate a modified web response. The operations further comprise processing the web response to determine a security enhancement to apply to the web resource associated with the web application based on the security configuration information for the web application. The operations further comprise modifying the web resource by applying the security enhancement to the web resource to generate a modified web resource. The operations further comprise providing the modified web response having the HTTP security header inserted therein and the modified web resource having the security enhancement to the client application in response to the web request for the web resource.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 is a flow diagram that illustrates an operation of a communication system in an exemplary embodiment.

FIG. 2 is a flow diagram that illustrates an operation of a communication system in an exemplary embodiment.

FIG. 3 is a block diagram that illustrates a communication system in an exemplary embodiment.

FIG. 4 is a block diagram that illustrates a communication system in an exemplary embodiment.

FIG. 5 is a block diagram that illustrates a communication system in an exemplary embodiment.

FIG. 6 is a block diagram that illustrates a communication system in an exemplary embodiment.

FIG. 7 is a flow diagram that illustrates an operation of the communication system in an exemplary embodiment.

FIG. 8 is a block diagram that illustrates a computing system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Existing methods of disseminating browser standards use manual processes where the user has to specify the security policies, without significant security knowledge and awareness of the implications. Further, these methods do not provide fine-grained controls such as the ability to apply stricter policies to the browsers that support them and less strict policies for older browser versions. The insertion of cryptographic nonces and hashes for web pages is a manual process that developers often have to perform themselves leading to a large cost and time overhead. In short, these processes are manual and do not provide an accurate and custom security policy for the end-user for each web site visit.

An explosion of third-party code in web applications and changes in web application architecture to become more client-heavy has led to recent web application attacks. This disclosure outlines an automated approach for accurately inserting and disseminating security policies and practices, called a web module, which will precisely and scalably integrate as a plug-in to a network device to carry out these functionalities. Further, the entire workflow is automated to ensure that any manual steps are only performed one time and that security policies and settings are periodically updated using feedback loops. Beneficially, these techniques allow users to easily deploy the next generation of precise security controls on their web applications to protect against web application attacks.

In particular, the present disclosure describes techniques for automatically disseminating web browser security standards, without the need for manual configuration by the web application developers In some implementations, a security web module functions as a software add-on or plug-in service worker that is able to integrate with network devices such as web servers (e.g., Apache®), web application frameworks (such as Node.js®), load balancers (such as NGINX®), reverse web proxies, CDNs, web proxies, browser proxies, client proxies, and client web browser applications. Once installed at one of these networking components, subsequent web requests will be protected from third-party code vulnerabilities and client-side vulnerabilities such as cross-site scripting (XSS) and other code injection attacks.

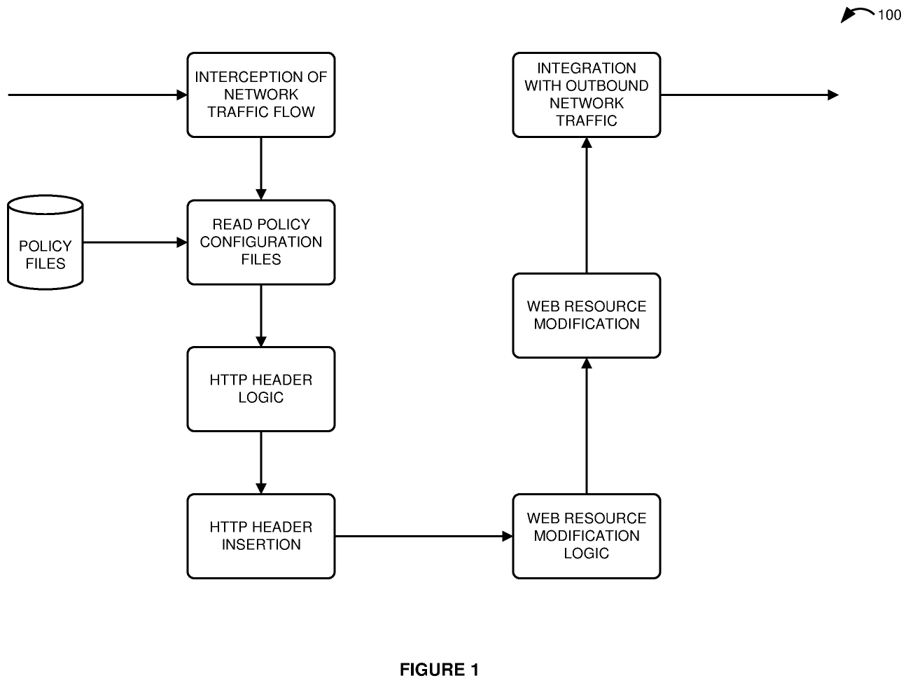

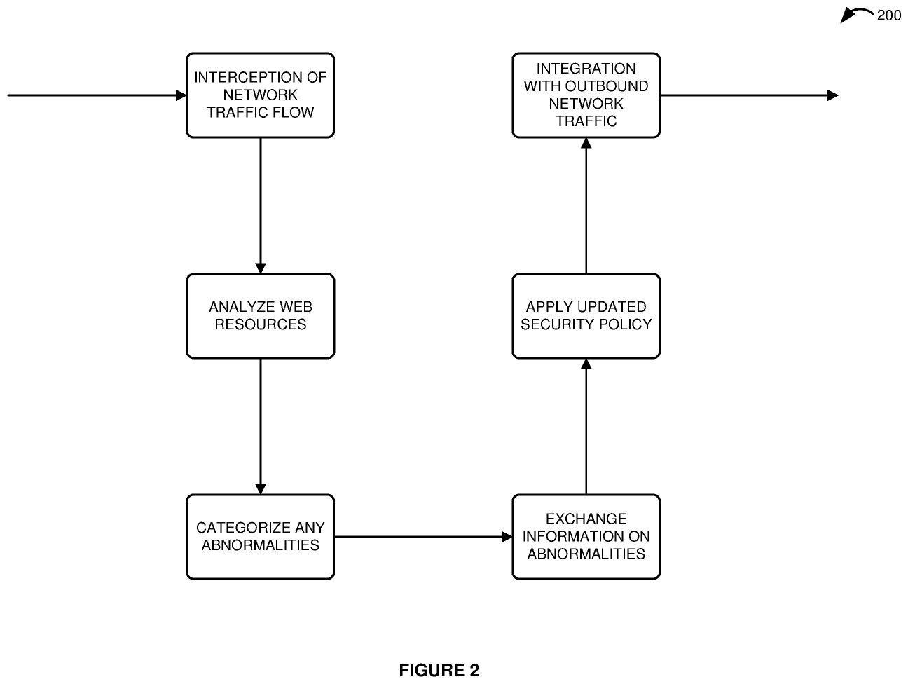

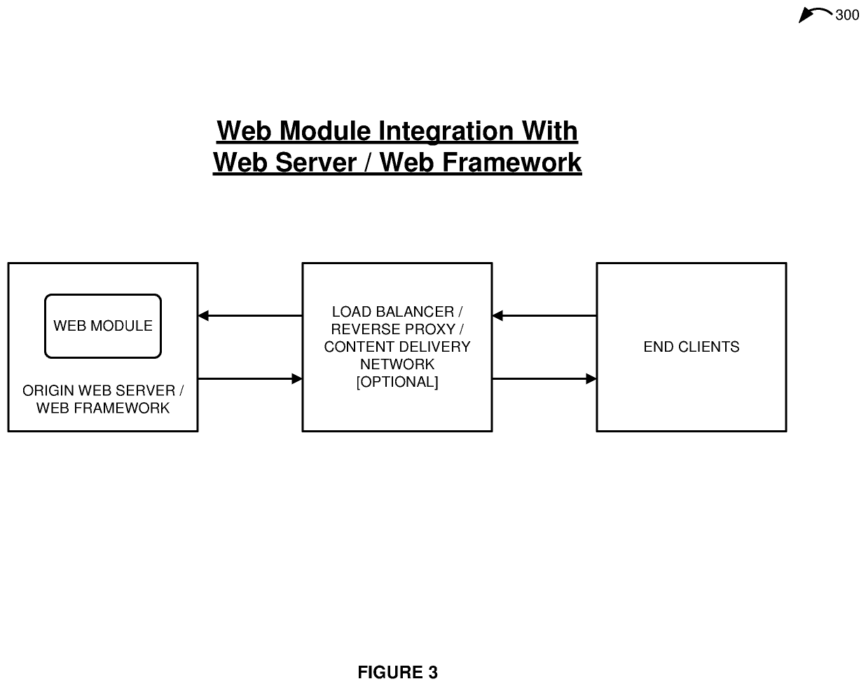

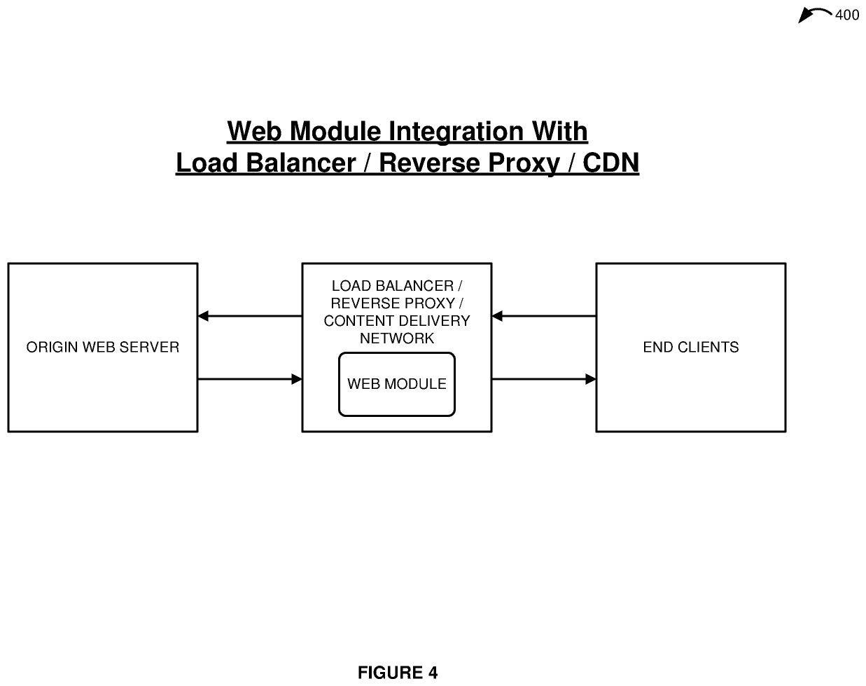

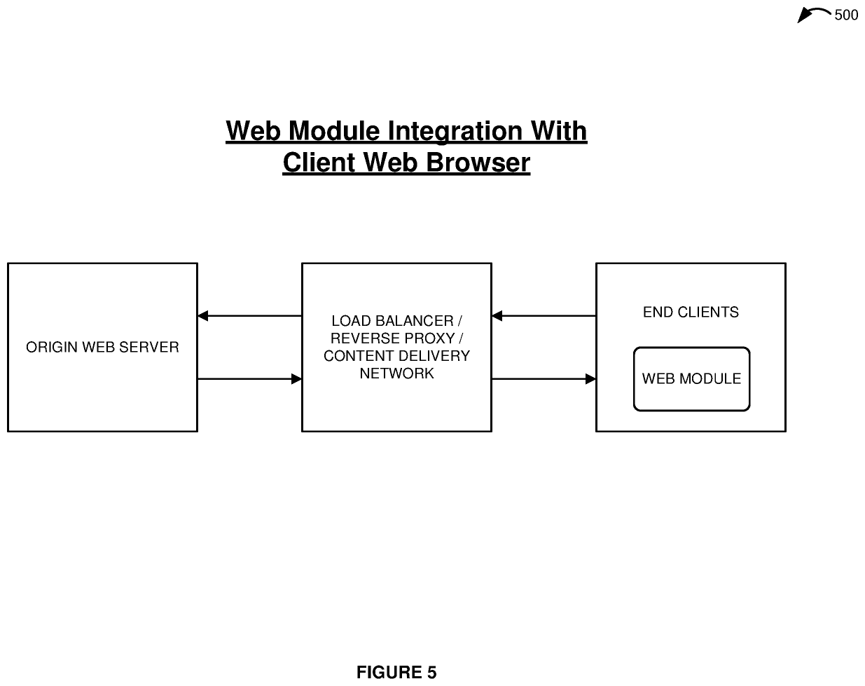

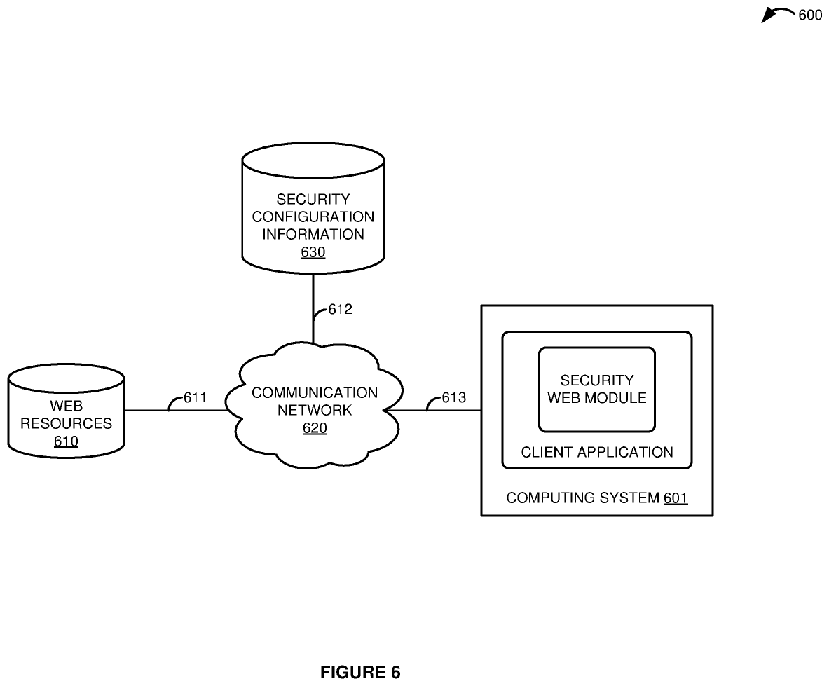

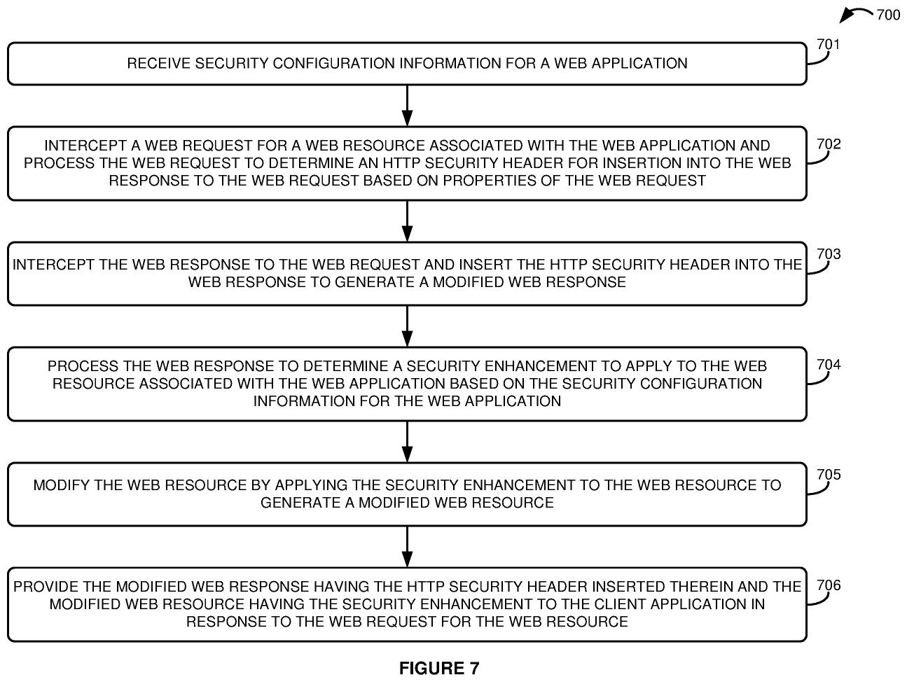

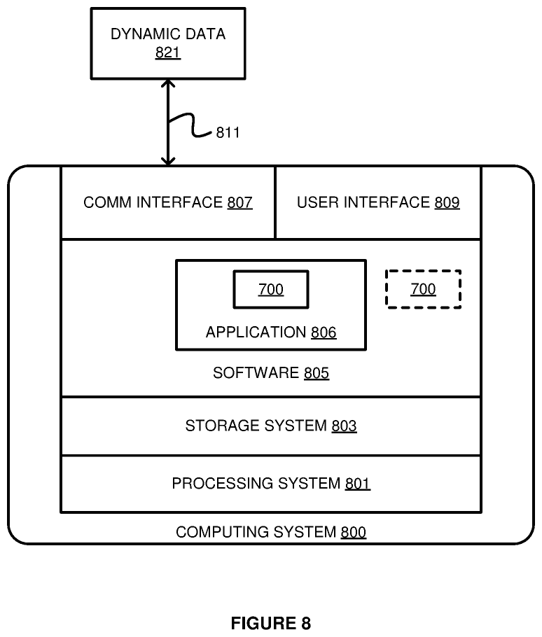

Referring now to the drawings, FIG. 1 is a flow diagram that illustrates how a web module could function within a networking device in an exemplary embodiment. FIG. 2 is a flow diagram that illustrates how a feedback mechanism could function within a networking device in an exemplary embodiment. FIG. 3 is a block diagram that illustrates how a web module could reside within an origin web server or a web framework in an exemplary embodiment. FIG. 4 is a block diagram that illustrates how a web module could reside within an intermediary networking device such as a load balancer, reverse proxy, or CDN in an exemplary embodiment. FIG. 5 is a block diagram that illustrates how a web module could reside within an endpoint networking device on the client side, such as a web browser or client-side proxy in an exemplary embodiment. FIG. 6 is a block diagram that illustrates a communication system that may be used to facilitate automatic insertion of security policies for web applications in an exemplary embodiment. FIG. 7 is a flow diagram that illustrates an operation of a computing system to execute an automatic web security process in an exemplary embodiment. Finally, FIG. 8 illustrates an exemplary computing system that may be used to perform any of the automatic web security processes and operational scenarios described herein.

Turning now to FIG. 1, a flow diagram of communication system 100 is illustrated. Communication system 100 describes an operational flow of a steady state of a web module in an exemplary embodiment. In at least one implementation, the web module may be installed within a networking device as an add-on service worker or software plug-in application to provide the additional security features described herein. In some implementations, the web module may be installed on a server-side networking device such as a web server or web application framework, or installed on an intermediary networking device such as a reverse proxy, load balancer, or CDN, or installed on a client-side endpoint networking device for execution on a client application such as a client web browser application, client proxy, or browser proxy, among other examples.

In operation, for a networking device, the web module directs the networking device to intercept the network traffic flow, which could differ depending on where the web module is installed and executing. For example, a web module installed on a server-side networking device such as an origin web server may intercept and view incoming network requests from a client and outgoing network responses from the server to the client, whereas a web module installed on a client-side networking device such as a web browser application running on a client computing system could intercept outgoing network requests from the client and incoming network responses from the server. Accordingly, the web module is designed to provide multiple points of integration, such as with a web server, a load balancer, a reverse proxy, a web middleware, a serverless compute environment, a Function as a Service (FaaS) provider, a CDN, or a web browser. Regardless, the web module generally executes on a networking device to integrate with the network traffic to be able to intercept incoming and outgoing network requests and responses.

Once the integration is complete, the web module may read the security configurations from the file system or any other data storage system, or request these settings through the network. For example, the web module could direct the networking device to read security configuration files from the file system, over the Internet, or any other source of security information policy files, including combinations thereof. In at least one implementation, the web module may also process the security configurations to build an optimized internal data structure that is fast and memory efficient.

After acquiring the security policy information, the web module determines the security enhancements and modifications that can be made to the web resource. For example, when an incoming web request comes in, the web module could determine the appropriate HTTP header or headers for injection into the response based on the request properties, such as the requested web resource or other properties of the web request.

The web module may then direct the networking device to intercept outgoing responses to web resource requests. Once a response to a web resource request is intercepted, the web module may perform the task of HTTP security header insertion. For example, when a web request has been serviced by the web server, the web module may direct the networking device to intercept the same outgoing response traffic to the web request to perform the actual HTTP header insertion into the response. In some implementations, the web module may insert HTTP security and privacy headers based on security configuration files for web resources, incoming traffic configurations such as a request uniform resource locator (URL) and the User-Agent header, and the requested web resource.

Based on the outgoing web response, the web module may determine the appropriate security enhancements and modifications that can be performed to the actual web resource, based on the security configuration files. In at least one implementation, the web module may utilize an optimized internal data structure of the security configurations that is fast and memory efficient in order to determine the security enhancements and modifications to apply to the actual web resource.

After determining the security enhancements to apply to the web resource, the web module may direct the networking device to perform the task of web resource modification. The security enhancements are then performed on the web resource, such as cryptographic nonce, cryptographic hash, security text, and JavaScript insertion, modification, and deletion. For example, in some implementations, the web module may enhance the web resource security and privacy on-the-fly by performing resource modification such as insertion, modification, removal, and refreshes of cryptographic hashes, cryptographic nonces, JavaScript functions, similar security text, and standard HTML, security and privacy attributes.

In at least one implementation, the response HTTP security headers and the modified web resource may then be integrated together into one final web resource. This security-enhanced web resource may then be integrated back into the outbound network traffic. For example, the web module may then direct the networking device to reintegrate the final web resource having the security enhancement modifications and the inserted HTTP security headers with the outgoing network traffic to ensure a seamless end-client experience. In at least one implementation, the end-client web browser application could receive the security-enhanced web resource and response having the HTTP security headers inserted therein, and the client web browser would process the security headers in the response to apply the appropriate security mechanisms, such as CSP, SRI, HSTS, and any other web browser security standards to help to prevent exploitation of vulnerabilities. In this manner, web requests for web resources, such as a web page, that are issued by the client browser will be protected from compromised third-party code and client-side vulnerabilities such as XSS and other code injection attacks.

Beneficially, the steady state operation of the web module described above provides for the automatic configuration of security and performance services. For example, the web module can optimize performance when launched in a short-lived ephemeral instance in serverless environments over security. Conversely, the web module can optimize security, for example, when launched in protection for sensitive financial web applications by automating the insertion of security practices, security policies, and security headers. The web module provides multiple points of integration, such as integration with the web server, CDN, or client web browser application. The web module can further provide custom security configurations based on web application resources and web application owner preferences, and scalably allows the dissemination of these security practices and policies across a variety of web applications. Another operation of the web module when operating in a feedback state will now be described with respect to FIG. 2.

FIG. 2 is a flow diagram that illustrates an operation of communication system 200. Communication system 200 describes an operational flow of a feedback state of a web module in an exemplary embodiment. The exemplary flow diagram of FIG. 2 illustrates how a feedback mechanism of the web module could function within a networking device. In at least one implementation, the web module may be installed within a networking device as an add-on service worker or software plug-in application to provide the additional security features described herein. In some implementations, the web module may be installed on a server-side networking device such as a web server or web application framework, or installed on an intermediary networking device such as a reverse proxy, load balancer, or CDN, or installed on a client-side endpoint networking device for execution on a client application such as a client web browser application, client proxy, or browser proxy, among other examples.

In operation, for a networking device, the web module directs the networking device to track the web resources that pass through the web module during steady state operation as described above with respect to FIG. 1. For example, the web module in feedback state could maintain a comprehensive list of all the outgoing web resources that flow through the web module and the networking device. In some implementations, the web module directing the networking device to track the web resources could differ depending on where the web module is installed and executing, as discussed above. For example, a web module installed on a server-side networking device such as an origin web server may track outgoing web resources and responses from the server to the client, whereas a web module installed on a client-side networking device such as a web browser application running on a client computing system could track incoming web resources and responses from the server to the client. Regardless, during feedback operation, the web module generally executes on a networking device to integrate with the network traffic to be able to track the web resources that pass through the web module.

The web module may then analyze each web resource to determine any security abnormalities. For example, in at least one implementation, the web module may perform static analysis on at least some portion of the web resource to identify any security risks or abnormalities. In some implementations, each web resource is analyzed to check for any vulnerabilities that may exist within it, such as new or vulnerable JavaScript code, vulnerable web domains, and any other potential security vulnerabilities.

Based on this analysis, web resources, or at least a portion of a web resource, will be determined as an abnormality. After determining that at least some portion of a web resource is an abnormality, the web module may categorize any abnormalities. For example, in at least one implementation, each abnormality may be classified into a specific category by the web module.

In some implementations, the identified abnormalities and any categorizations of the abnormalities are exchanged between different web modules and a centralized control center. For example, in at least one implementation, the web module may transfer this information for further analysis based on the security configurations across multiple web module deployments.

Based on the decision by the centralized control center, a new policy configuration may need to be applied. In at least one implementation, this security configuration is enabled by the web module in steady state. For example, the web module may apply any new security policies obtained in steady state as a result of these enhancements and refinements determined during feedback state.

The web resource with the newly-applied security policies may then be integrated with the outbound network traffic. For example, the web module may direct the networking device to reintegrate a final modified web resource having the newly-applied security enhancement modifications and HTTP security headers with the outgoing network traffic to further improve end-client security. In this manner, the web module operating in the feedback state is able to efficiently and securely obtain updated security and privacy characteristics as a feedback mechanism in order to continuously improve the security and privacy policies in an automated manner for the web application.

Advantageously, the feedback state operation of the web module described above provides for the ability to enhance security and privacy policies over time. For example, the web module may configure and set the security and privacy levels of the policies used in real-time. For example, the web module may send a low security policy when the web application has been only partially analyzed so as not to break the functionality of the web resource and yet still enable some detection of potential security threats. The feedback mechanism in the web module will then enhance the policy through its cycles to generate and apply a more strict policy over time. The web module also provides for delivering policies that conform to previously-generated models of web applications, using an offline analysis of the web application using static, dynamic, and metadata analysis techniques. In at least one implementation, the web module may also be configured to identify and stop, in real-time, certain threats and attacks that deviate from the previously-generated model of the web application. The security techniques disclosed herein envision providing an automated workflow for the above features and maintaining a remote control center for these, such as a central controller. An example of the web module deployed in a server-side networking device such as a web server will now be described with respect to FIG. 3.

FIG. 3 is a block diagram of communication system 300 that illustrates how a web module could reside within an origin web server or a web framework in an exemplary embodiment. In this example, the web module is installed as a plug-in or add-on software application on the origin web server or web framework and runs alongside the web server or web framework hosting infrastructure. For example, when installed on a web server, the web module could comprise a standalone application that runs side by side on the server to automatically improve security of web applications provided by the web server. In some implementations, when the web module is integrated with the web server or web framework, a load balancer, reverse proxy, CDN, or other intermediary networking devices may also be optionally employed, which would generally operate between the origin web server and the end clients as shown in communication system 300.

In some implementations, the web module installed on the web server could operate as described herein for the steady state operation of FIG. 1 and the feedback state operation of FIG. 2, among other operations and variations thereof. For example, the web module integrated with the web server or web framework could direct the web server to intercept the network traffic flow in order to view and analyze incoming network requests from a client and outgoing network responses from the server to the client. Then, after acquiring the security policy information, the web module may determine the security enhancements and modifications to apply for a requested web resource. For example, when an incoming web request is received by the web server, the web module could determine the appropriate HTTP security headers for injection into the response based on the request properties, such as the requested web resource. The web module may then direct the web server to intercept outgoing responses to web resource requests and insert the HTTP security headers into the responses. Based on the outgoing web response and the security configuration files, the web module may then determine the appropriate security enhancements and modifications to apply to the actual web resource. The web module then performs the security enhancements on the web resource, such as cryptographic nonce, cryptographic hash, similar security text, and JavaScript insertion, modification, and deletion. The web module may then direct the web server to reintegrate the final web resource having the security enhancement modifications and the inserted HTTP security headers with the outgoing network traffic for delivery to the end client. An example of the web module deployed in an intermediary networking device such as a CDN, reverse proxy, or load balancer will now be described with respect to FIG. 4.

FIG. 4 is a block diagram of communication system 400 that illustrates how a web module could reside within an intermediary networking device such as a load balancer, reverse proxy, or CDN in an exemplary embodiment. In this example, the web module is installed as a plug-in or add-on software application on an intermediary networking device such as a load balancer, reverse proxy, or CDN and runs alongside the intermediary networking infrastructure. For example, when installed on a CDN, the web module could comprise a standalone application that runs side by side on the CDN to automatically improve security of web applications and web resources provided by the CDN. In at least one implementation, the web module could be provided to the CDN as code to be run on the CDN as a Function as a Service (FaaS). The web module could operate in a similar manner when integrated with a load balancer, reverse proxy, or other intermediary networking devices in some examples.

In some implementations, the web module installed on a load balancer, reverse proxy, CDN, or other intermediary networking device could operate as described herein for the steady state operation of FIG. 1 and the feedback state operation of FIG. 2, among other operations and variations thereof. For example, the web module integrated with the load balancer, reverse proxy, or CDN could direct the load balancer, reverse proxy, or CDN to intercept the network traffic flow in order to view and analyze incoming network requests from a client and outgoing network responses to the client. Then, after acquiring the security policy information, the web module may determine the security enhancements and modifications to apply for a requested web resource. For example, when an incoming web request is processed by the load balancer, reverse proxy, or CDN, the web module could determine the appropriate HTTP security headers for injection into the response based on the request properties, such as the requested web resource. The web module may then direct the load balancer, reverse proxy, or CDN to intercept outgoing responses to web resource requests and insert the HTTP security headers into the responses. Based on the outgoing web response and the security configuration files, the web module may then determine the appropriate security enhancements and modifications to apply to the actual web resource. The web module then performs the security enhancements on the web resource, such as cryptographic nonce, cryptographic hash, similar security text, and JavaScript insertion, modification, and deletion. The web module may then direct the load balancer, reverse proxy, or CDN to reintegrate the final web resource having the security enhancement modifications and the inserted HTTP security headers with the outgoing network traffic for delivery to the end client. An example of the web module deployed in a client-side networking device such as a web browser will now be described with respect to FIG. 5.

FIG. 5 is a block diagram of communication system 500 that illustrates how a web module could reside within an endpoint networking device on the client side, such as a web browser or client-side proxy in an exemplary embodiment. In this example, the web module is installed as a plug-in or add-on software application on a client networking device and runs alongside the client networking infrastructure. For example, when installed on a client computing system executing a web browser application, the web module could comprise JavaScript code or some other script that is executed by the web browser on the client system to automatically improve security of web applications and web resources requested by the client. In some implementations, when the web module is integrated with the client networking device, a load balancer, reverse proxy, CDN, or other intermediary networking devices may also be optionally employed, which would generally operate between the origin web server and the end clients as shown in communication system 500.

In some implementations, the web module installed on the client networking device could operate as described herein for the steady state operation of FIG. 1 and the feedback state operation of FIG. 2, among other operations and variations thereof. For example, the web module integrated with a client web browser application could direct the client computing system to intercept the network traffic flow in order to view and analyze outgoing network requests from the client and incoming network responses to the client. Then, after acquiring the security policy information, the web module may determine the security enhancements and modifications to apply for a requested web resource. For example, when an outgoing web request is sent by the client web browser, such as a request for a web page or other web resource, the web module could determine the appropriate HTTP security headers for injection into the response based on the request properties, such as the requested web resource. The web module may then direct the client web browser to intercept incoming responses to web resource requests and insert the HTTP security headers into the responses. Based on the incoming web response and the security configuration files, the web module may then determine the appropriate security enhancements and modifications to apply to the actual web resource. The web module then performs the security enhancements on the web resource, such as cryptographic nonce, cryptographic hash, similar security text, and JavaScript insertion, modification, and deletion. The web module may then direct the client web browser to reintegrate the final web resource having the security enhancement modifications and the inserted HTTP security headers with the incoming network traffic for delivery to the end client. Another example of a security web module executing in a client application such as a web browser will now be described with respect to FIG. 6.

FIG. 6 is a block diagram that illustrates communication system 600 that may be used to facilitate automatic insertion of security policies for web applications in an exemplary embodiment. Communication system 600 includes web resources 610, communication network 620, security configuration information 630, and computing system 601. Web resources 610 may be provided over communication network 620 via communication link 611, while security configuration information 630 may be provided over communication network 620 via communication link 612. Computing system 601 and communication network 620 communicate over communication link 613. In some examples, computing system 601 could comprise a client computing system, such as a smartphone, tablet, laptop, client proxy, browser proxy, or any other client system. Computing system 601 includes a client application installed thereon, such as a client web browser application, client proxy, browser proxy, or some other client software application. In this implementation, the client application includes a security web module which executes in conjunction with the client application. For example, modern web browsers have a standard to accept code directly, such as JavaScript, and run that code before every web page is loaded. In this case, the web module described herein may be coded as JavaScript code and provided to the client web browser application as an additional resource when the web browser requests the web application. The web browser will then run the web module code as a browser service worker to perform the security techniques described herein prior to loading any web resources of the web application requested by the client in order to apply the appropriate security policies.

In some implementations, web resources 610 could comprise any resources used in the provision of a web application, such as scripts, code libraries, web pages, hypertext markup language (HTML) code, fonts, style sheets, plugins, tag managers, JavaScript files, and any other web application components, which may be stored on a database or some other data storage system that provides web resources 610 for a web application. In at least one implementation, web resources 610 could be part of an origin web server that provides the web application, which may include internal inline scripts that are embedded into HTML pages, but web resources 610 could also represent first-party web resources of the web application owner that are provided via CDNs and other external data sources. Additionally or alternatively, web resources 610 could also represent external web resources that are provided by third parties, such as advertisers or external libraries, which would also be served by external data sources. An exemplary implementation for operating computing system 601 to automatically apply security for a web resource 610 associated with a web application will now be discussed with respect to FIG. 7.

FIG. 7 is a flow diagram that illustrates an operation 700 of communication system 600. The operation 700 shown in FIG. 7 may also be referred to as automatic web security process 700 herein. The steps of the operation are indicated below parenthetically. The following discussion of operation 700 will proceed with reference to computing system 601 and web resources 610 of FIG. 6 in order to illustrate its operations, but note that the details provided in FIG. 6 are merely exemplary and not intended to limit the scope of process 700 to the specific implementation shown in FIG. 6.

Operation 700 may be employed by computing system 601 to facilitate automatic insertion of security policies for web applications. In operation, computing system 601 executes a security web module in a client application to perform operations. In some examples, the client application could comprise a client web browser application, client proxy, browser proxy, or any other client application. For example, in some implementations, the security web module could be installed on computing system 601 as a plug-in or add-on software application that runs alongside the client application, such as a client proxy or browser proxy. In at least one implementation, when installed on a client computing system 601 executing a web browser application, the security web module could comprise JavaScript code or some other script that is executed by the web browser on computing system 601 to automatically improve security of web applications and web resources requested by the client. In some implementations, computing system 601 could receive the security web module from the web application. For example, in at least one implementation, the security web module may be coded as JavaScript code and provided to the client web browser application as an additional resource when the web browser requests the web application. In some implementations, the security web module could comprise script code to be run by the client application prior to loading the web application. For example, the client web browser could run the security web module code as a browser service worker to perform the security techniques described herein prior to loading any web resources of the web application requested by the client in order to apply the appropriate security policies to the web resources. Regardless of the specific implementation, computing system 601 executes the security web module in a client application to perform the following operations.

As shown in the operational flow of FIG. 7, computing system 601 executes the security web module to receive security configuration information for a web application (701). In at least one implementation, the security configuration information is provided by an organization associated with the web application, such as an owner of the web application, security personnel, security consultants, or any other entity associated with the web application. In some implementations, the security web module may read the security configuration information from a file system or any other data storage system, or request these settings through a network, such as communication network 620. For example, the security web module could direct computing system 601 to read the security configuration information from the file system, over the Internet, or any other source of security information policy files, including combinations thereof. In at least one implementation, the security web module may also process the security configurations to build an optimized internal data structure that is fast and memory efficient.

Computing system 601 executes the security web module to intercept a web request for a web resource 610 associated with the web application and process the web request to determine an HTTP security header for insertion into a web response to the web request based on properties of the web request (702). In some examples, the requested web resource 610 could comprise building blocks for constructing web applications, which may be requested by a client to load a webpage. For example, web resource 610 may include web pages, JavaScript code, third-party libraries, HTML, code, font, scripts, style sheets, plugins, tag managers, or any other web application components. The requested web resource 610 may be received by computing system 601 from any source, but would generally be received from web servers, CDNs, reverse proxies, load balancers, third-party computing systems, cloud services, or any other data sources that may provide web resources 610 for the web application. In some implementations, the security web module generally executes on computing system 601 to integrate with the network traffic to be able to intercept the web request for the web resource associated with the web application. For example, in at least one implementation, the security web module directs computing system 601 to intercept the network traffic flow in order to intercept outgoing web requests from the client and incoming web responses.

After intercepting the web request, the security web module directs computing system 601 to process the web request to determine an HTTP security header for insertion into a web response to the web request based on properties of the web request. In some implementations, upon intercepting the web request, the security web module could determine the appropriate HTTP header or headers for injection into the web response to the web request based on the request properties, such as the requested web resource, incoming traffic configurations such as a request URL and information in the User-Agent request header, or other properties of the web request. For example, in at least one implementation, the security web module could process the web request to determine the HTTP security header for insertion into the web response to the web request based on the properties of the web request by processing the web request to determine the HTTP security header for insertion into the web response to the web request based on the web resource requested in the web request.

Computing system 601 executes the security web module to intercept the web response to the web request and insert the HTTP security header into the web response to generate a modified web response (703). In some implementations, the security web module generally executes on computing system 601 to integrate with the network traffic to be able to intercept the web response to the web request for the web resource associated with the web application. For example, in at least one implementation, the security web module directs computing system 601 to intercept the network traffic flow in order to intercept incoming web responses to the client. Once the web response to the web request for the web resource is intercepted, the security web module may perform the task of HTTP security header insertion. For example, in at least one implementation, when the web request has been serviced by the web server, the security web module may direct computing system 601 to intercept the same incoming web response traffic to the web request to perform the actual HTTP header insertion into the web response. In this manner, the security web module generates a modified web response which comprises the web response having the HTTP security header inserted therein. In some examples, the HTTP security header inserted into the web response could comprise comprises a content security policy (CSP) header, an HTTP strict transport security (HSTS) header, a subresource integrity (SRI) integrity values, or any other security headers or values.

Computing system 601 executes the security web module to process the web response to determine a security enhancement to apply to the web resource associated with the web application based on the security configuration information for the web application (704). For example, in some implementations, the security web module may process the intercepted web response to determine the appropriate security enhancements and modifications that can be made to the actual web resource, based on the security configuration information. In at least one implementation, the security web module may utilize an optimized internal data structure of the security configuration information that is fast and memory efficient in order to determine the security enhancements and modifications to apply to the actual web resource. In some implementations, the security enhancements that may be made to the web resource include insertion, modification, removal, and refreshes of cryptographic nonces, cryptographic hashes, SRI integrity values, similar security text, JavaScript functions, and standard HTML, security and privacy attributes, among other security enhancements.

In general, the security configuration information for the web application dictates the security enhancements that should be applied to the web resource. However, in some implementations, the security enhancements could also be determined additionally or alternatively by the security web module itself. For example, in at least one implementation, the security web module could be configured to determine a type of the web resource and automatically apply additional security for the web resource based on the type of web resource. In some implementations, the security web module could analyze the web resource to identify whether the web resource is a home page or general information page of a web application, or a more critical type of page such as a login page where a user enters account credentials or a checkout page on a shopping website where a user enters payment information. For example, in at least one implementation, the security web module may parse the web resource to analyze the resource, and if the web module logic detects credit card entry forms that are present on the web resource, the security web module may automatically increase security for the web resource by applying additional security enhancements to the web resource. In this manner, when the security web module determines that the web resource is a more critical type of resource that requires additional security, the security web module can alter the security policies to harden or increase the security policies accordingly.

Computing system 601 executes the security web module to modify the web resource by applying the security enhancement to the web resource to generate a modified web resource (705). In some implementations, after determining the security enhancements to apply to the web resource, the security web module may direct computing system 601 to perform the task of web resource modification. In some implementations, the security web module modifies the web resource by applying the security enhancement to the web resource, such as cryptographic nonce, cryptographic hash, SRI integrity values, similar security text, JavaScript insertion, modification, and deletion, and standard HTML security and privacy attributes, among other security enhancements. In this manner, the security web module generates a modified web resource which comprises the web resource having the security enhancement applied thereto.

Computing system 601 executes the security web module to provide the modified web response having the HTTP security header inserted therein and the modified web resource having the security enhancement to the client application in response to the web request for the web resource (706). In at least one implementation, in order to provide the modified web response and the modified web resource to the client, the security web module may integrate the modified web response having the HTTP security header and the modified web resource having the security enhancement together into one final security-enhanced web resource. This security-enhanced web resource may then be integrated back into the incoming network traffic received by the client application. For example, in at least one implementation, the security web module may direct computing system 601 to reintegrate the final security-enhanced web resource having the security enhancement modifications and the inserted HTTP security header with the incoming network traffic received by the client application to ensure a seamless end-client experience. In at least one implementation, where the client application comprises a client web browser application, the web browser application could receive the security-enhanced web resource and web response having the HTTP security header inserted therein, and the client web browser would process the security header in the web response to apply the appropriate security mechanisms, such as CSP, HSTS, SRI integrity checks, and any other web browser security standards to help to prevent exploitation of vulnerabilities. In this manner, web requests for web resources, such as a web page, that are issued by the client web browser will be protected from compromised third-party code and client-side vulnerabilities such as XSS and other code injection attacks.

In some implementations, computing system 601 may further execute a feedback process as described herein with respect to FIG. 2. For example, in at least one implementation, computing system 601 could maintain a comprehensive list of all web resources associated with the web application. Computing system 601 may then perform vulnerability analysis on the web resources to check for vulnerabilities, and determine an unsecure web resource of the web resources based on the vulnerability analysis. In some implementations, computing system 601 may determine the unsecure web resource by identifying at least some portion of the unsecure web resource as having a vulnerability or some other security abnormality. In at least one implementation, after determining that at least some portion of a web resource is unsecure or has an abnormality, computing system 601 may categorize any security vulnerabilities or abnormalities. For example, each vulnerability or abnormality identified may be classified into specific categories by computing system 601. Computing system 601 may then inform a central controller about the unsecure web resource determined based on the vulnerability analysis. In some implementations, the identified abnormalities and any categorizations of the abnormalities may be exchanged between different web modules and the centralized control center. For example, in at least one implementation, computing system 601 may transfer this information for further analysis by the central controller based on the security configurations across multiple web module deployments. Based on the decision by the central controller, a new policy configuration may need to be applied. Computing system 601 may then receive the new security policy configuration for the unsecure web resource from the central controller, and apply the new security policy configuration for the unsecure web resource whenever the unsecure web resource is requested by the client application. In at least one implementation, this security configuration is enabled by the web module in steady state. For example, the security web module may apply any newly-obtained security policies in steady state operation as a result of these enhancements and refinements determined during the feedback state.

Advantageously, the security techniques disclosed herein provide for the automated dissemination of web security and privacy policies, improved security and privacy practices, and security headers for client-side security enhancements in a scalable manner. Further, by intercepting the web responses, custom security configurations can be inserted automatically based on web application resources and user requirements as defined in security configuration information. The techniques also allow for customization of security and privacy settings for every client browser and client version type, at the granularity of individual web resources and web pages, entire websites, or portions of the website. In this manner, the deployment, manageability, security patching and updating of security and privacy policies, security and privacy practices, and security and privacy enhancements may be fully automated for improved client-side web security.

Now referring back to FIG. 6, computing system 601 may be representative of any computing apparatus, system, or systems on which the techniques disclosed herein or variations thereof may be suitably implemented. Computing system 601 comprises a processing system and communication transceiver. Computing system 601 may also include other components such as a router, server, data storage system, and power supply. Computing system 601 may reside in a single device or may be distributed across multiple devices. Computing system 601 be a discrete system or may be integrated within other systems, including other systems within communication system 600. Some examples of computing system 601 include desktop computers, laptop computers, cloud computing platforms, and virtual machines, as well as any other type of computing system, variation, or combination thereof. In some examples, computing system 601 could comprise a client computing system, laptop computer, tablet, smartphone, client proxy, browser proxy, network switch, router, switching system, packet gateway, network gateway system, Internet access node, application server, database system, service node, firewall, or some other communication system, including combinations thereof.

Web resources 610 may be provided by any computing apparatus, system, or systems that may connect to another computing system over a communication network. Web resources 610 may be provided by systems that could comprise a data storage system and communication transceiver. Web resources 610 may be provided by systems that could also include other components such as a processing system, router, server, and power supply. Web resources 610 may reside in a single device or may be distributed across multiple devices. Web resources 610 may be provided by a discrete system or may be provided by multiple systems, including other systems within communication system 600. Some examples of systems that may provide web resources 610 include file systems, database systems, desktop computers, server computers, cloud computing platforms, and virtual machines, as well as any other type of computing system, variation, or combination thereof.

Communication network 620 could comprise multiple network elements such as routers, gateways, telecommunication switches, servers, processing systems, or other communication equipment and systems for providing communication and data services. In some examples, communication network 620 could comprise wireless communication nodes, telephony switches, Internet routers, network gateways, computer systems, communication links, or some other type of communication equipment, including combinations thereof. Communication network 620 may also comprise optical networks, packet networks, local area networks (LAN), metropolitan area networks (MAN), wide area networks (WAN), or other network topologies, equipment, or systems, including combinations thereof. Communication network 620 may be configured to communicate over wired or wireless communication links. Communication network 620 may be configured to use Internet Protocol (IP), Ethernet, optical networking, wireless protocols, communication signaling, or some other communication format, including combinations thereof. In some examples, communication network 620 includes further access nodes and associated equipment for providing communication services to several computer systems across a large geographic region.

Security configuration information 630 may be provided by any computing apparatus, system, or systems that may connect to another computing system over a communication network. Security configuration information 630 may be provided by systems that could comprise a data storage system and communication transceiver. Security configuration information 630 may be provided by systems that could also include other components such as a processing system, router, server, and power supply. Security configuration information 630 may reside in a single device or may be distributed across multiple devices. Security configuration information 630 may be provided by a discrete system or may be provided by multiple systems, including other systems within communication system 600. Some examples of systems that may provide security configuration information 630 include file systems, database systems, desktop computers, server computers, cloud computing platforms, and virtual machines, as well as any other type of computing system, variation, or combination thereof.

Communication links 611, 612, and 613 use metal, air, space, optical fiber such as glass or plastic, or some other material as the transport medium, including combinations thereof. Communication links 611, 612, and 613 could use various communication protocols, such as IP, Ethernet, optical networking, wireless protocols, communication signaling, or some other communication format, including combinations thereof. Communication links 611, 612, and 613 could be direct links or may include intermediate networks, systems, or devices.

Turning now to FIG. 8, a block diagram is shown that illustrates computing system 800 in an exemplary implementation. Computing system 800 provides an example of computing system 601, or any computing system that may be used to execute automatic web security process 700 or variations thereof, although computing system 601 could use alternative configurations. Computing system 800 includes processing system 801, storage system 803, software 805, communication interface 807, and user interface 809. User interface 809 comprises display system 808. Software 805 includes application 806 which itself includes automatic web security process 700. Application 806 provides an example of a client application, although a client application could use alternative configurations in some implementations. Application 806 may also provide an example of a security web module, although a security web module could use alternative configurations in some implementations. Automatic web security process 700 may optionally be implemented separately from application 806, as indicated by the dashed line in FIG. 8. In some implementations, automatic web security process 700 may be encoded into or otherwise provided by a security web module.

Computing system 800 may be representative of any computing apparatus, system, or systems on which application 806 and automatic web security process 700 or variations thereof may be suitably implemented. Examples of computing system 800 include mobile computing devices, such as cell phones, tablet computers, laptop computers, notebook computers, and gaming devices, as well as any other type of mobile computing devices and any combination or variation thereof. Note that the features and functionality of computing system 800 may apply as well to desktop computers, server computers, and virtual machines, as well as any other type of computing system, variation, or combination thereof.

Computing system 800 includes processing system 801, storage system 803, software 805, communication interface 807, and user interface 809. Processing system 801 is operatively coupled with storage system 803, communication interface 807, and user interface 809. Processing system 801 loads and executes software 805 from storage system 803. When executed by computing system 800 in general, and processing system 801 in particular, software 805 directs computing system 800 to operate as described herein for automatic web security process 700 or variations thereof. Computing system 800 may optionally include additional devices, features, or functionality not discussed herein for purposes of brevity.

Referring still to FIG. 8, processing system 801 may comprise a microprocessor and other circuitry that retrieves and executes software 805 from storage system 803. Processing system 801 may be implemented within a single processing device but may also be distributed across multiple processing devices or sub-systems that cooperate in executing program instructions. Examples of processing system 801 include general purpose central processing units, application specific processors, and logic devices, as well as any other type of processing device, combinations, or variations thereof.

Storage system 803 may comprise any computer-readable storage media capable of storing software 805 and readable by processing system 801. Storage system 803 may include volatile and nonvolatile, removable and non-removable media implemented in any method or technology for storage of information, such as computer readable instructions, data structures, program modules, or other data. Storage system 803 may be implemented as a single storage device but may also be implemented across multiple storage devices or sub-systems co-located or distributed relative to each other. Storage system 803 may comprise additional elements, such as a controller, capable of communicating with processing system 801. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the computer-readable storage media a propagated signal.

In operation, processing system 801 may load and execute portions of software 805, such as automatic web security process 700, to operate as described herein for automatic web security process 700 or variations thereof. Software 805 may be implemented in program instructions and among other functions may, when executed by computing system 800 in general or processing system 801 in particular, direct computing system 800 or processing system 801 to execute a security web module to receive security configuration information for a web application. Software 805 may further direct computing system 800 or processing system 801 to execute the security web module to intercept a web request for a web resource associated with the web application and process the web request to determine an HTTP security header for insertion into a web response to the web request based on properties of the web request. In addition, software 805 directs computing system 800 or processing system 801 to execute the security web module to intercept the web response to the web request and inserting the HTTP security header into the web response to generate a modified web response. Software 805 may further direct computing system 800 or processing system 801 to execute the security web module to process the web response to determine a security enhancement to apply to the web resource associated with the web application based on the security configuration information for the web application. Software 805 may also direct computing system 800 or processing system 801 to execute the security web module to modify the web resource by applying the security enhancement to the web resource to generate a modified web resource. Software 805 may further direct computing system 800 or processing system 801 to execute the security web module to provide the modified web response having the HTTP security header inserted therein and the modified web resource having the security enhancement to the client application in response to the web request for the web resource.

Software 805 may include additional processes, programs, or components, such as operating system software or other application software. Examples of operating systems include Windows®, iOS®, and Android®, as well as any other suitable operating system. Software 805 may also comprise firmware or some other form of machine-readable processing instructions executable by processing system 801.

In general, software 805 may, when loaded into processing system 801 and executed, transform computing system 800 overall from a general-purpose computing system into a special-purpose computing system customized to facilitate automatic insertion of security policies for web applications as described herein for each implementation. For example, encoding software 805 on storage system 803 may transform the physical structure of storage system 803. The specific transformation of the physical structure may depend on various factors in different implementations of this description. Examples of such factors may include, but are not limited to the technology used to implement the storage media of storage system 803 and whether the computer-storage media are characterized as primary or secondary storage.

In some examples, if the computer-storage media are implemented as semiconductor-based memory, software 805 may transform the physical state of the semiconductor memory when the program is encoded therein. For example, software 805 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 800 is generally intended to represent a computing system with which software 805 is deployed and executed in order to implement application 806 and/or automatic web security process 700 (and variations thereof). However, computing system 800 may also represent any computing system on which software 805 may be staged and from where software 805 may be distributed, transported, downloaded, or otherwise provided to yet another computing system for deployment and execution, or yet additional distribution. For example, computing system 800 could be configured to deploy software 805 over the internet to one or more client computing systems for execution thereon, such as in a cloud-based deployment scenario.

Communication interface 807 may include communication connections and devices that allow for communication between computing system 800 and other computing systems (not shown) or services, over a communication network 811 or collection of networks. In some implementations, communication interface 807 receives dynamic data 821 over communication network 811. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 809 may include a voice input device, a touch input device for receiving a gesture from a user, a motion input device for detecting non-touch gestures and other motions by a user, and other comparable input devices and associated processing elements capable of receiving user input from a user. Output devices such as display system 808, speakers, haptic devices, and other types of output devices may also be included in user interface 809. The aforementioned user input devices are well known in the art and need not be discussed at length here. User interface 809 may also include associated user interface software executable by processing system 801 in support of the various user input and output devices discussed above. Separately or in conjunction with each other and other hardware and software elements, the user interface software and devices may provide a graphical user interface, a natural user interface, or any other kind of user interface. User interface 809 may be omitted in some examples.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a computing system to facilitate automatic insertion of security policies for web applications, the method comprising:
executing a security web module in a client application to perform operations, the operations comprising:
receiving security configuration information for a web application;
intercepting a web request for a web resource associated with the web application and processing the web request to determine a hypertext transfer protocol (HTTP) security header for insertion into a web response to the web request based on properties of the web request;
intercepting the web response to the web request and inserting the HTTP security header into the web response to generate a modified web response;
processing the web response to determine a security enhancement to apply to the web resource associated with the web application based on the security configuration information for the web application;
modifying the web resource by applying the security enhancement to the web resource to generate a modified web resource; and
providing the modified web response having the HTTP security header inserted therein and the modified web resource having the security enhancement to the client application in response to the web request for the web resource.

2. The method of claim 1 wherein the operations further comprise:
maintaining a comprehensive list of all web resources associated with the web application;
performing vulnerability analysis on the web resources to check for vulnerabilities;
determining an unsecure web resource of the web resources based on the vulnerability analysis;
informing a central controller about the unsecure web resource determined based on the vulnerability analysis;
receiving the new security policy configuration for the unsecure web resource from the central controller; and
applying the new security policy configuration for the unsecure web resource whenever the unsecure web resource is requested by the client application.

3. The method of claim 1 wherein processing the web request to determine the HTTP security header for insertion into the web response to the web request based on the properties of the web request comprises processing the web request to determine the HTTP security header for insertion into the web response to the web request based on the web resource requested in the web request.

4. The method of claim 1 further comprising receiving the security web module from the web application.

5. The method of claim 1 wherein the security web module comprises script code to be run by the client application prior to loading the web application.

6. The method of claim 1 wherein the HTTP security header inserted into the web response comprises a content security policy (CSP) header.

7. The method of claim 1 wherein the HTTP security header inserted into the web response comprises an HTTP strict transport security (HSTS) header.

8. One or more computer-readable storage media having program instructions stored thereon to facilitate automatic insertion of security policies for web applications, wherein the program instructions, when executed by a computing system, direct the computing system to at least:
execute a security web module in a client application to perform operations, the operations comprising:
receiving security configuration information for a web application;
intercepting a web request for a web resource associated with the web application and processing the web request to determine a hypertext transfer protocol (HTTP) security header for insertion into a web response to the web request based on properties of the web request;
intercepting the web response to the web request and inserting the HTTP security header into the web response to generate a modified web response;
processing the web response to determine a security enhancement to apply to the web resource associated with the web application based on the security configuration information for the web application;
modifying the web resource by applying the security enhancement to the web resource to generate a modified web resource; and
providing the modified web response having the HTTP security header inserted therein and the modified web resource having the security enhancement to the client application in response to the web request for the web resource.

9. The one or more computer-readable storage media of claim 8 wherein the operations further comprise:
maintaining a comprehensive list of all web resources associated with the web application;
performing vulnerability analysis on the web resources to check for vulnerabilities;
determining an unsecure web resource of the web resources based on the vulnerability analysis;
informing a central controller about the unsecure web resource determined based on the vulnerability analysis;
receiving the new security policy configuration for the unsecure web resource from the central controller; and
applying the new security policy configuration for the unsecure web resource whenever the unsecure web resource is requested by the client application.

10. The one or more computer-readable storage media of claim 8 wherein processing the web request to determine the HTTP security header for insertion into the web response to the web request based on the properties of the web request comprises processing the web request to determine the HTTP security header for insertion into the web response to the web request based on the web resource requested in the web request.

11. The one or more computer-readable storage media of claim 8 wherein the program instructions further direct the computing system to receive the security web module from the web application.

12. The one or more computer-readable storage media of claim 8 wherein the security web module comprises script code to be run by the client application prior to loading the web application.

13. The one or more computer-readable storage media of claim 8 wherein the HTTP security header inserted into the web response comprises a content security policy (CSP) header.

14. The one or more computer-readable storage media of claim 8 wherein the HTTP security header inserted into the web response comprises an HTTP strict transport security (HSTS) header.

15. An apparatus to facilitate automatic insertion of security policies for web applications, the apparatus comprising:
one or more computer-readable storage media;
a processing system operatively coupled with the one or more computer-readable storage media; and
program instructions stored on the one or more computer-readable storage media that, when executed by the processing system, direct the processing system to execute a security web module in a client application to perform operations, the operations comprising:
receiving security configuration information for a web application;
intercepting a web request for a web resource associated with the web application and processing the web request to determine a hypertext transfer protocol (HTTP) security header for insertion into a web response to the web request based on properties of the web request;
intercepting the web response to the web request and inserting the HTTP security header into the web response to generate a modified web response;
processing the web response to determine a security enhancement to apply to the web resource associated with the web application based on the security configuration information for the web application;
modifying the web resource by applying the security enhancement to the web resource to generate a modified web resource; and
providing the modified web response having the HTTP security header inserted therein and the modified web resource having the security enhancement to the client application in response to the web request for the web resource.

16. The apparatus of claim 15 wherein the operations further comprise:
maintaining a comprehensive list of all web resources associated with the web application;
performing vulnerability analysis on the web resources to check for vulnerabilities;
determining an unsecure web resource of the web resources based on the vulnerability analysis;
informing a central controller about the unsecure web resource determined based on the vulnerability analysis;
receiving the new security policy configuration for the unsecure web resource from the central controller; and
applying the new security policy configuration for the unsecure web resource whenever the unsecure web resource is requested by the client application.

17. The apparatus of claim 15 wherein processing the web request to determine the HTTP security header for insertion into the web response to the web request based on the properties of the web request comprises processing the web request to determine the HTTP security header for insertion into the web response to the web request based on the web resource requested in the web request.

18. The apparatus of claim 15 wherein the security web module is received from the web application.

19. The apparatus of claim 15 wherein the security web module comprises script code to be run by the client application prior to loading the web application.

20. The apparatus of claim 15 wherein the HTTP security header inserted into the web response comprises a content security policy (CSP) header.
